(19) United States
(12) Patent Application Publication
(10) Pub. No.: US 2011/0085682 A1
(43) Pub. Date: Apr. 14, 2011

(54) APPARATUS AND METHOD FOR REPRODUCING MUSIC IN A PORTABLE TERMINAL

(75) Inventor: Young-Sik PARK, Daegu (KR)

(73) Assignee: SAMSUNG ELECTRONICS CO. LTD., Suwon-si (KR)

(21) Appl. No.: 12/902,351

(22) Filed: Oct. 12, 2010

(30) Foreign Application Priority Data
Oct. 13, 2009 (KR) 10-2009-0097365

(51) Int. Cl. H04B 1/00; G06F 3/01

(52) U.S. Cl. 381/119; 715/716

(57) ABSTRACT

A music reproducing apparatus includes: a Graphic User Interface (GUI) providing a guide for controlling an output of a music file, a display unit for displaying the GUI, a Beats Per Minute (BPM) providing unit for converting the music file into an analog form, and for separating a specific frequency component from the converted music file of the analog form to provide BPM information of the music file, and a control unit for comparing BPM information of at least two music files with each other according to the BPM information provided from the BPM providing unit to reproduce the music file by adjusting an output frequency.

### PRIORITY

This application claims the benefit under 35 U.S.C. §119(a) of a Korean patent application filed in the Korean Intellectual Property Office on Oct. 13, 2009 and assigned Serial No. 10-2009-0097365, the entire disclosure of which is hereby incorporated by reference.

### BACKGROUND OF THE INVENTION

1. Field of the Invention

The present invention relates to an apparatus and a method for reproducing music in a portable terminal. More particularly, the present invention relates to an apparatus and a method for reproducing music in a portable terminal, which can provide various effects to the reproduced music using a Disc Jockey (DJ) function such as a turntable and a mixer.

2. Description of the Related Art

Recently, portable terminals have been configured to perform various functions. The various functions include, for example, data and speech communication functions, a photographing function or a function for moving images through a camera, a speech storage function, a reproducing function of music files through a speaker system, and a display function of images or videos. Many portable terminals include an additional function for executing games, and some portable terminals are implemented as a multimedia device. Recent portable terminals may receive a broadcast or multicast signal to view a video or a television program. Accordingly, a user may be able to access and execute various multimedia by a portable terminal without needing to store and transport a separate Moving Picture Experts Group Audio Layer 3 (MP3) or moving image player.

However, in addition to portability, miniaturization or a lightweight size of the portable terminal has become a necessity. Because the portable terminal is designed thin and small in size, a user of the portable terminal with a music file reproducing function can simply listen to a music file according to a constantly fixed music reproduction application. Since music reproduction through the portable terminal may be output by one of a loud speaker, a headset, an earphone, and the like, satisfaction in listening to music being reproduced through the portable terminal is deteriorated. In this case, the loud speaker is a speaker that allows many users to listen to the music. The headset or earphone is a device that allows only one user to listen to the music.

Disc Jockey (DJ) techniques may include mixing and scratching. Mixing is a fundamental and essential technique of DJs that brings Beats Per Minutes (BPMs) of different pieces of music close to each other in order to connect the different pieces of music naturally. A scratched sound can show a DJ's personality and has a characteristic sound produced when a specific section of a record is moved forward and backwards.

Basic equipment of the DJ is a turntable and a mixer. The turntable is a device that allows a user to listen to a Long-Playing (LP) record. The mixer is a device that naturally mixes sounds input through plural channels, and mixes two pieces of music reproduced together on two turntables. A cross fader mounted to a mixer is an important tool used in scratching, and may implement various scratching sounds.

To execute a DJ function, there is a need for many audio devices with large volume and low portability. To execute a DJ function capable of expressing various personalities to a fixed reproduced music, a user must have professional experience and knowledge.

A mobile device such as a portable terminal reproduces music according to a music reproducing application through an output of one of a loud speaker or an earphone. Accordingly, the mobile device cannot reproduce music suited to a user's taste and a user's creative music similar to a DJ function. When the music is output through one of the loud speaker or the earphone, separate music cannot be simultaneously output.

Since analog devices such as a turntable, an amplifier, and a sound mixer necessary to execute a professional DJ function have large volume and low portability, it is very difficult to apply the professional DJ function to a thin and small designed portable terminal

Furthermore, when an existing user executes the professional DJ function such as switching of a piece of music or a mixer, two different pieces of music are connected and mixed to thereby reduce a rhythmical sense. When music is reproduced, an effect in reproducing a corresponding music file is reduced.

Therefore, a need exists for an apparatus and method for reproducing music in a portable terminal having a DJ function.

### SUMMARY OF THE INVENTION

An aspect of the present invention is to address at least the above-mentioned problems and/or disadvantages and to provide at least the advantages described below. Accordingly, an aspect of the present invention is to provide a music reproducing apparatus of a portable terminal with a Disc Jockey (DJ) mixer function, and a method thereof. The DJ mixer function may be capable of simulating a DJ such as storage of music, selection of music, selection of a switching point, reproduction and switching of music that may reproduce music in various methods, express a user's personality according to the reproduction of music, synthesize and store music simultaneously reproduced in plural channels, thereby improving convenience for a user and increasing utility of the portable terminal according to the reproduction of music.

Another aspect of the present invention is to provide a music reproducing apparatus that allows a general user without professional experience and knowledge with respect to Beats Per Minute (BPM) to easily fulfill the function and role of a DJ in mixing and switching of a piece of music using a portable terminal by reproducing and switching music through using BPM information of a corresponding music file while reproducing the music through the plural channels.

In accordance with an aspect of the present invention, a music reproducing apparatus of a portable terminal is provided. The apparatus includes a Graphical User Interface (GUI) for providing a guide for controlling an output of a music file, a display unit for displaying the GUI, a BPM providing unit for converting the music file into an analog form, and for separating a specific frequency component from the converted music file to provide BPM information of the music file, and a control unit for comparing BPM information of at least two music files with each other according to the BPM information provided from the BPM providing unit, and for controlling to reproduce the music file by adjusting an output frequency.

In accordance with another aspect of the present invention, a music reproducing method of a portable terminal is provided. The method includes displaying a GUI providing a guide for controlling output of a music file on a display unit, selecting a music file to be reproduced through plural channels to simultaneously reproduce the selected music file through output units corresponding to the plural channels, displaying currently reproduced music file information or BPM information of the music file in a certain channel according to a user input, and switching a music file which is being reproduced in a certain channel to another music file which is being reproduced in another channel by setting a reproducing time or reproducing point of a corresponding music file, and mixing the switched music file with different channel outputs from each other to create and store one music file.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a music reproducing apparatus of a portable terminal according to an exemplary embodiment of the present invention;

FIG. 2 is a block diagram illustrating a music reproducing apparatus of a portable terminal according to an exemplary embodiment of the present invention;

FIG. 3 is a flowchart illustrating a music reproducing method of a portable terminal according to an exemplary embodiment of the present invention;

FIG. 4 is a flowchart illustrating a Beats Per Minute (BPM) information acquiring procedure in a music reproducing method of a portable terminal according to an exemplary embodiment of the present invention;

FIGS. 5A-5C illustrate examples of various Graphical User Interface (GUI) screens provided in a music reproducing method of a portable terminal according to an exemplary embodiment of the present invention;

FIGS. 6A and 6B illustrate examples of a main view among various GUI screens provided in a music reproducing method of a portable terminal according to an exemplary embodiment of the present invention;

FIG. 7 illustrates examples of various GUI screens displaying a plurality of effects in respective modes in a music reproducing method of a portable terminal according to an exemplary embodiment of the present invention; and

FIGS. 8A and 8B illustrate examples of screens respectively indicating a music waveform and BPM information of a corresponding music file in a music reproducing method of a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a music file reproducing apparatus of a portable terminal included in various portable devices, such as a portable terminal, a digital camera, a navigational unit, a Portable Multimedia Player (PMP), and the like. Accordingly, the term “portable terminal” denotes a portable device providing a function of reproducing an audio file.

Further, a music file according to an exemplary embodiment of the present invention may be supported in any of various formats such as a Moving Picture Experts Group Audio Layer 3 (MP3) file, an OGG file, a Windows Media Audio (WMA) file, an Advanced Systems Format (ASF) file, an Audio Video Interleave (AVI) file, and the like.

Moreover, a rotating turntable image may be displayed on a screen of the music reproducing apparatus of the portable terminal in a circular disk shape to implement a Disc Jockey (DJ) function during a reproducing function of music such that a user directly controls a disk of a corresponding music file using a touch screen method.

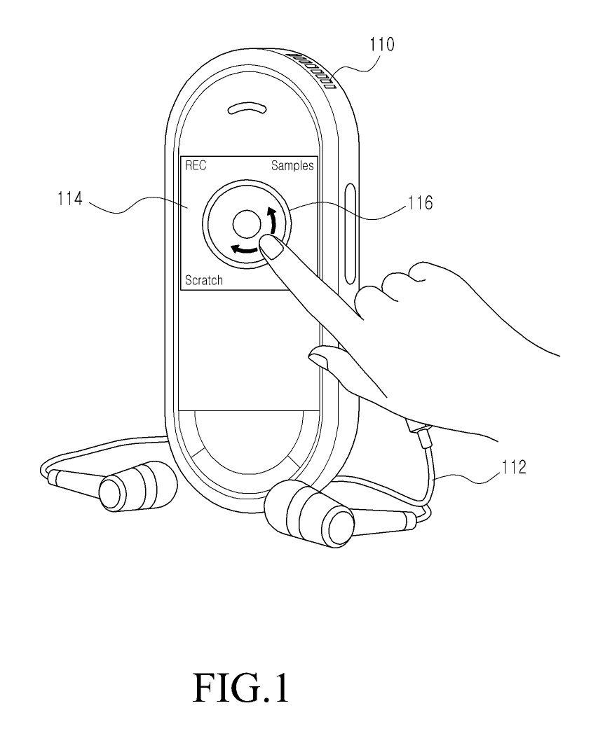

Hereinafter, a construction of the music reproducing apparatus of the portable terminal will be described with reference to FIG. 1 below.

FIG. 1 illustrates a music reproducing apparatus of a portable terminal according an exemplary embodiment of the present invention.

Referring to FIG. 1, the portable terminal includes a loud speaker output unit 110 provided at one side of the portable terminal, a headset or earphone output unit 112, and a display unit 114 provided at another side thereof to implement a DJ mixing function. The display unit 114 operates in a touch screen method.

As illustrated in FIG. 1, a user touches a Graphical User Interface (GUI) 116, which is disk shaped, corresponds to a currently reproduced music file, and is displayed on a display unit 114 according to a music reproduction application, using a finger to implement a DJ function such as bit mixing or scratching. That is, when a user touch input occurs on the GUI 116 and rotates in a left or right direction, the portable terminal detects a rotation direction and/or a rotation degree thereof and provides a detected signal to a control unit to thereby generate an effect sound such as preset scratching

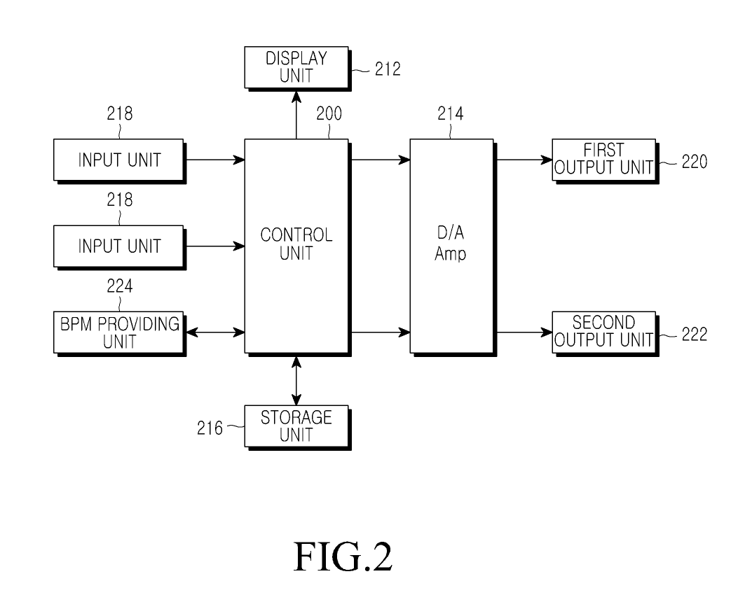

Hereinafter, a music reproducing apparatus of the portable terminal with a DJ mixing function according to an exemplary embodiment of the present invention will be described in more detail below with reference to FIG. 2.

FIG. 2 is a block diagram illustrating a music reproducing apparatus of a portable terminal according to an exemplary embodiment of the present invention.

Referring to FIG. 2, the music reproducing apparatus of the portable terminal includes a control unit 200, a GUI application 210, a display unit 212, a Digital/Analog (D/A) amplifier 214, a storage unit 216, an input unit 218, a first output unit 220, a second output unit 222, and a Beats Per Minute (BPM) providing unit 224.

The control unit 220 controls overall operations of the portable terminal. The control unit controls selection of a music file to be reproduced through plural channels, simultaneous reproduction of the selected music file through output units corresponding to respective channels, and switching of a music file which is being reproduced in a certain channel to a music file which is being reproduced in another channel by setting a reproducing time or a reproducing point of the music file which is being reproduced in the certain channel.

Further, the control unit 200 controls extraction, displaying, and reproduction of BPM information of stored music files through plural channels.

The BPM information denotes bit information with respect to data measuring the number and a period of records when a specific component is equal to or greater than a specific level.

In this case, the BPM information of a corresponding music file is acquired by the BPM providing unit 224. The BPM providing unit includes a decoder (not illustrated) that converts the music file into an analog music file, a filter (not illustrated) that separates a specific frequency component from the converted analog music file, and a BPM analyzing unit (not illustrated) that stores the BPM information of the music file transmitted through the filter and provides the stored BPM information of the music file when the BPM information is requested.

The control unit 200 compares respective BPM information of at least two music files with each other according to the BPM information from the BPM providing unit, and controls the reproduction of the music file by adjusting an output frequency of the music file.

More particularly, the control unit 200 acquires BPM information of different music files to be simultaneously reproduced through the plural channels and adjusts an output frequency of the music file, that is, a BPM pattern. The music files are reproduced and adjusted to efficiently perform switching of music by bringing BPMs of different pieces of music close to each other in order to connect the different pieces of music naturally for synchronization.

For example, when a short music track (i.e., one to four measures) with a clear beat pattern is switched to a general music track with a beat pattern, a BPM pattern of the general music is adjusted to synchronize with the beat of the music with the clear beat pattern. The adjusted BPM pattern is applied to a corresponding general music track to be used once or repeatedly used more than several times.

Moreover, the control unit switches a music file which is being reproduced in a certain channel to a music file which is being reproduced in another channel by setting a reproducing time or a reproducing point of the music file which is being reproduced in the certain channel, and mixes music files with switched different channel outputs to produce and store one music file. In this case, the reproducing time or the reproducing point denotes reproducing start and stop points of a corresponding music file, respectively.

For example, a first music file signal is output and reproduced through the first output unit 220, which may be a current loud speaker output unit so that many users may listen to the music. A user may simultaneously listen to the first music file signal reproduced through the first output unit 220 and a second music file signal output through a second output unit 222, which may be an ear phone or a headset.

At this time, when a user sets a specific reproduction stop time or point of the first music file reproduced through the first output unit 220 and listened to by many users, and then sets a specific reproducing start time or point of a music file reproducing through the second output unit 222, the control unit 200 controls to switch the specific reproduction stop time or point set to the first music file to a reproduction start time or point set to a music file reproduced through the second output unit 222.

Further, the control unit 200 controls to output the music file through the first output unit 220 after a specific reproduction time or point set to the second music file next to the specific reproduction time or point set to the first music file.

Moreover, the control unit 200 controls to mix the first and second music files switched with each other at the specific reproduction time or point to create and store one music file in the storage unit 216.

In this case, the plural channels may be divided into a first channel and a second channel. The first channel and the second channel are previously set corresponding to a first output unit 220 and a second output unit 222, respectively.

More particularly, the control unit 200 controls the selection of a music file to be reproduced by loading music files stored in the storage unit 216 through the first channel and the second channel, and a simultaneous output of corresponding music files selected from respective channels through respective output units 220 and 222.

In addition, the GUI application 210 provides a guide for controlling an output of a music file to a user. When a user touch input is detected through the input unit 218, the GUI application 210 adjusts a shape of the guide under the control of the control unit 200.

More particularly, when a user requests a conversion from a general call idle mode to a music reproducing mode using the input unit 218, the GUI application 210 displays an initial screen informing of the entering of the converted music reproduction mode. The GUI application includes a main view, a wave view, and a mixer view.

The main view displays information of a music file reproduced through at least one channel by loading a plurality of music files, and displays a switching point setting a specific reproducing position or time of a corresponding music file at a corresponding progress bar of the currently reproduced music file when a current reproduction is converted.

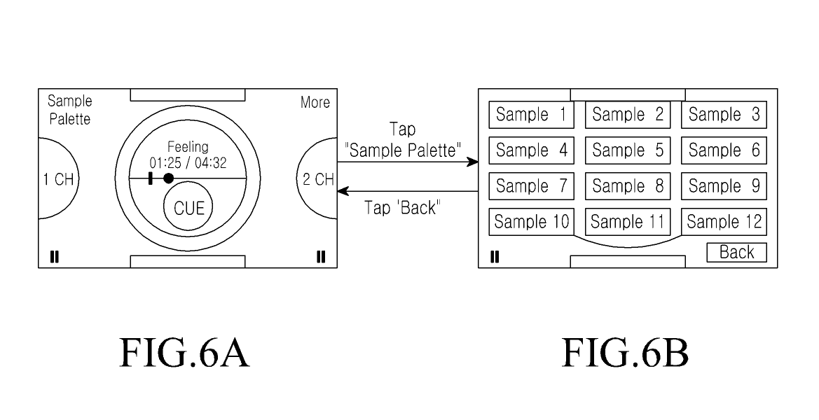

FIGS. 6(A) and 6(B) illustrate examples of a main view among various GUI screens provided in a music reproducing method of a portable terminal according to an exemplary embodiment of the present invention.

Referring to FIG. 6(A), in the main view, when a “Sample Palette” area displayed on a preset area of the main view is tapped or otherwise selected by a user, the screen is overlaid with a display in which a plurality of “Samples”, that is, listed music files, is shown as illustrated in FIG. 6(B). From the display of FIG. 6B, the user may select one of the plurality of “Samples” or return to the main view by selecting “Back.”

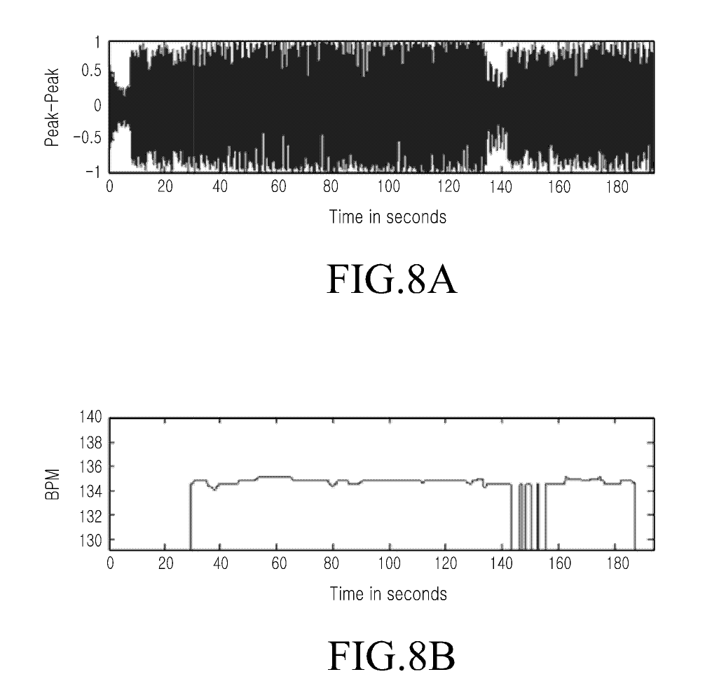

FIGS. 8(A) and 8(B) illustrate examples of screens respectively indicating a music waveform and BPM information of a corresponding music file in a music reproducing method of a portable terminal according to an exemplary embodiment of the present invention.

Referring to FIGS. 8(A) and 8(B), a wave view displays a corresponding waveform and BPM information of a music file to be reproduced through the plural channels, and provides a User Interface (UI) for receiving a switching point of a corresponding music file to be reproduced after a currently reproduced music file is set by a user.

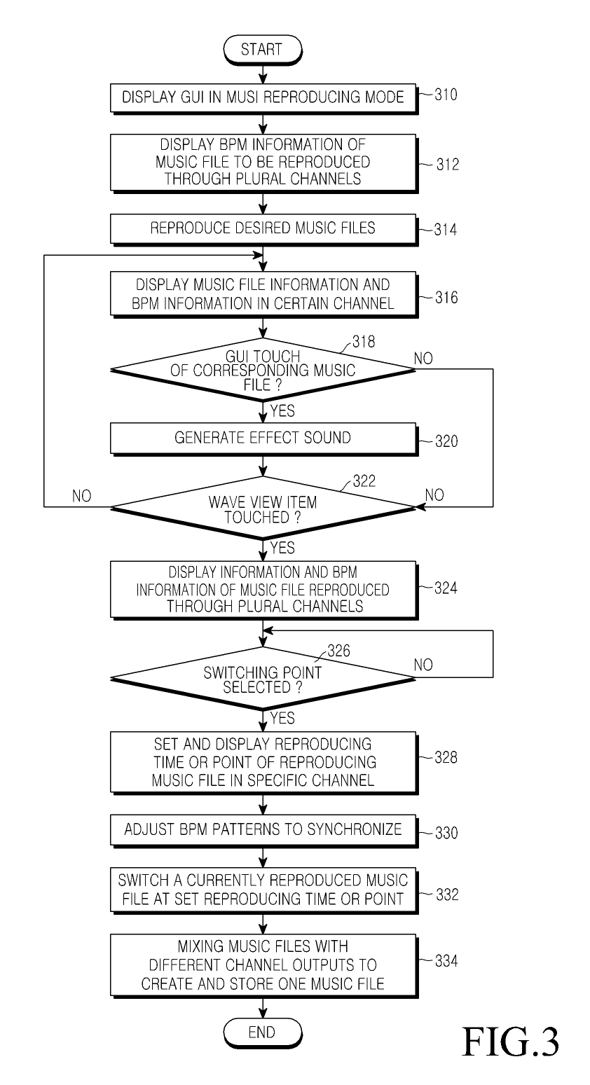

The mixer view creates and displays a reproducing music file in the plural channels as one music file by setting a switching point to a file to be reproduced next in a currently reproduced music file in a certain channel. The three views of the GUI application 210 in a music reproducing method of a portable terminal will be described in more detail below with reference to FIG. 3.

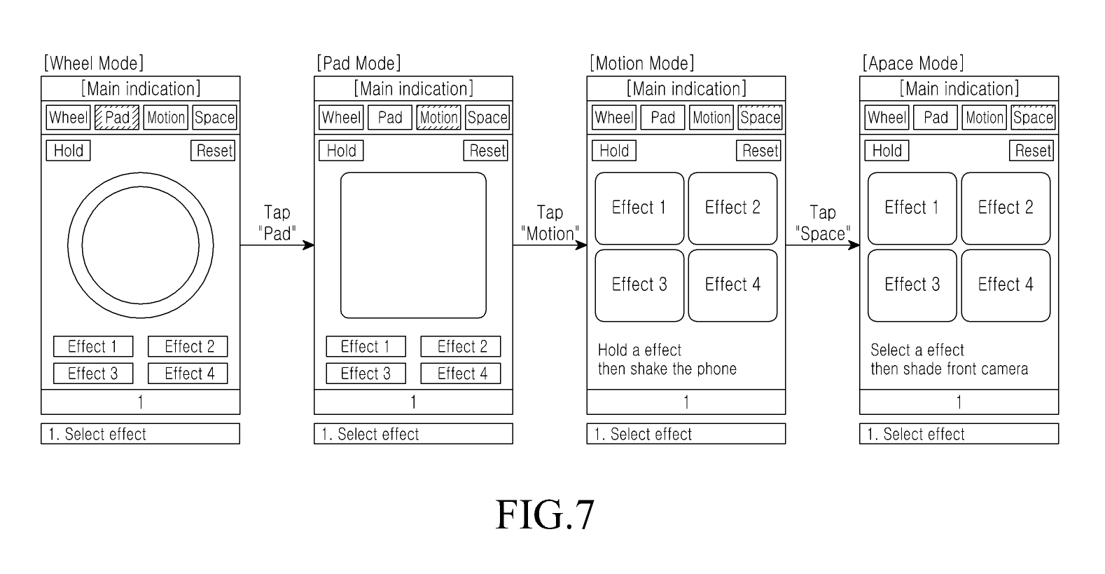

FIG. 7 illustrates examples of various GUI screens displaying a plurality of effects in respective modes in a music reproducing method of a portable terminal according to an exemplary embodiment of the present invention.

The effects denote various DJ technologies, for example, looping, auto-panning, and echo using BPM information in reproducing a corresponding music file. The effects displayed in each mode are previously set to apply an effect sound or operation previously set by a user's selection to a reproducing music file.

Referring back to FIG. 2, the storage unit 216 may be configured by a program memory or a data memory. The program memory stores programs for controlling a general operation of the portable terminal, and executes a function storing a plurality of music files which may be loaded through the plural channels according to an exemplary embodiment of the present invention. Furthermore, the storage unit 216 stores a preset music file that is mixed and generated as one music file while reproducing music files through plural channels under the control of the control unit 200. The storage unit also receives and stores corresponding BPM information of the music file from the BPM providing unit 224.

The D/A amplifier 214 D/A converts and outputs a signal of a corresponding music file output through plural channels under the control of the control unit 200.

The music file signals of respective channels input from the D/A amplifier 214 are output through a first output unit 220 or a second output unit 222 previously set to the respective channels.

The input unit 218 detects a user touch input on a preset area and outputs the user touch to the control unit 200. For example, when a disk shaped GUI displayed on the display unit 212 rotates in a left or right direction according to a user touch input, the input unit 218 detects a rotation direction and a rotation degree, and provides a detected signal to the control unit 200 so that the control unit generates an effect sound such as preset scratching

That is, a user generates input data for controlling an operation of the portable terminal. The input unit 218 may be configured by a key pad, a dome switch, a touch pad, a jog wheel, a jog switch, and the like. More particularly, when the touch pad achieves a mutual layer structure with a display unit 212, the touch pad may be recognized as a touch screen.

The display unit 212 displays information processed by the portable terminal, that is, a GUI under the control of the control unit 200. For example, when the portable terminal is in a call mode, the display unit 212 displays an UI or GUI associated with a call. Meanwhile, when the portable terminal is in a music reproducing mode, the display unit 212 displays a GUI regarding music file information and an output thereof.

Hereinafter, a music reproducing method of a portable terminal using a music reproducing apparatus according to an exemplary embodiment of the present invention as described above will be described in more detail below with reference to FIG. 3.

FIG. 3 is a flowchart illustrating a music reproducing method of a portable terminal according to an exemplary embodiment of the present invention.

Referring to FIG. 3, the portable terminal enters a music reproducing mode from a preset mode to display a GUI providing a guide for controlling output of a music file on a display unit in step 310.

The GUI provides a guide for controlling the output of the music file to a user, and adjusts a shape of the guide according to a user touch input.

The display unit 212 displays BPM information of a music file to be reproduced through plural channels in step 312.

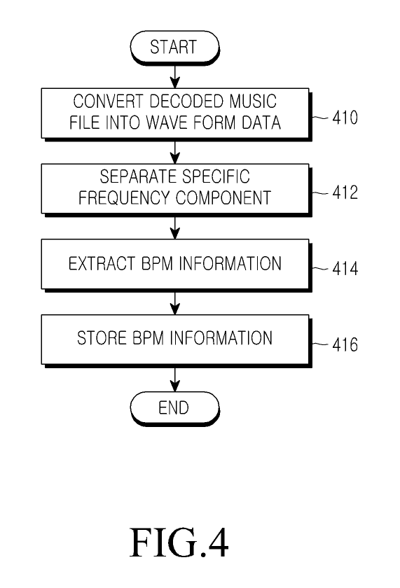

Here, a procedure for acquiring BPM information will be described in more detail with reference to FIG. 4.

FIG. 4 is a flowchart illustrating a BPM information acquiring procedure in a music reproducing method of a portable terminal according to an embodiment of the present invention.

When a corresponding BPM information display command of a music file is input by a user, a decoded music file is converted into data in a wave form in step 410.

A specific frequency component, that is, a high or low frequency component is separated from the converted wave data by a filter in step 412.

Information regarding the number and a period of records when a specific component is equal to or greater than a threshold level is collected and BPM information of a corresponding music file is extracted and acquired from the collected information in step 414.

The acquired BPM information of a corresponding music file is stored in step 416.

Referring back to FIG. 3, in step 314, a desired music file is reproduced through plural channels.

In step 314, reproduced music file information may be displayed together with corresponding BPM information in a specific channel through the GUI.

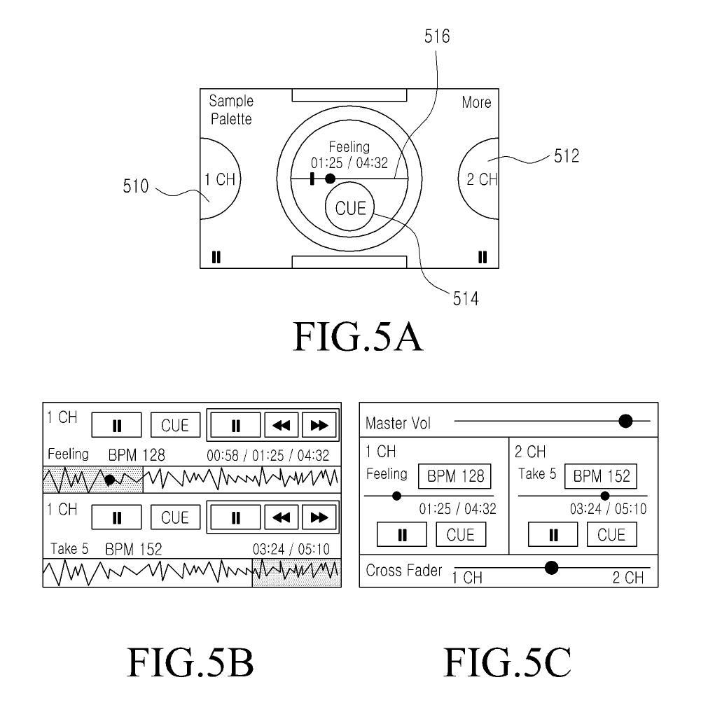

In this case, the GUI includes a main view, a wave view, and a mixer view, as illustrated in FIGS. 5A, 5B, and 5C.

FIGS. 5A-5C illustrate an example of various GUI screens provided in a music reproducing method of a portable terminal according to an exemplary embodiment of the present invention.

Referring to FIG. 5A, a main view loads a plurality of music files to display information of a music file reproduced through at least one channel, and displays a switching point setting a specific reproducing position or time of a corresponding music file at a corresponding progress bar 516 of the currently reproduced music file through a switching point 514 when a current reproduction is converted.

Referring to FIG. 5B, a wave view displays a corresponding waveform of a music file to bring the BPMs of different pieces of music to be reproduced through the plural channels close to each other in order to connect the different pieces of music naturally, and provides a user interface through which a switching point of a music file to be reproduced after the currently reproduced music file from the user.

Referring to FIG. 5C, a mixer view creates and displays a currently reproduced music file in the plural channels as one music file by setting a switching point to a file to be reproduced next in a currently reproduced music file in a specific channel executed in the wave view.

As described above, in step 314, a corresponding music file is selected and reproduced by loading music files through plural channels displayed on a main view of FIG. 5(A), that is, a first channel 510 and a second channel 512.

Referring back to FIG. 3, in step 316, as illustrated in FIG. 5(A), currently reproduced music file information, for example, track name, reproducing time (04:32), reproducing point (01:25), and BPM information of a corresponding music file are displayed in a specific channel.

In step 318, the portable terminal determines whether a user touch occurs on a corresponding GUI indicating information of the music file. If it is determined that the user touch occurs, a preset effect sound is generated in step 320.

In other words, a GUI of a circular disk shape with a switching point 514 and a progress bar 516 in the main view of FIG. 5A is created to implement a DJ function. For example, when the user gently rubs the disk shaped GUI by hand, of a Long-Playing (LP) record such as scratching occurs.

Here, the user touch input denotes a short touch, a long touch, flicking, a drag, and the like.

If it is determined that the user touch does not occur in the GUI displaying information of the music file in step 318, the portable terminal determines whether a user touch input occurs on a wave view item in a preset area of the main view in step 322.

If it is determined that the user touch input occurs, information and BPM information of a music file to be reproduced through plural channels are displayed in step 324, as illustrated in FIG. 5B.

The displayed wave view displays a corresponding waveform of a music file being reproduced through the plural channels to bring the BPMs of different pieces of music close to each other in order to connect the different pieces of music naturally.

A switching point GUI previously set or to be set in the plural channels are displayed to determine whether a switching point of a specific reproducing time or point of a music file reproduced in a certain channel is selected by a user in step 326. When the switching point is selected, the specific reproducing time or point of a music file reproduced in the certain channel is set and displayed in step 328.

BPM patterns of different music files reproduced through plural channels are adjusted and synchronized in step 330.

The BPM patterns are adjusted and synchronized to efficiently perform switching of music by bringing the BPMs of different pieces of music close to each other in order to connect and synchronize the different pieces of music naturally.

In step 332, a currently reproduced music file is switched at the reproducing time or point set.

Music files with different channel outputs are mixed to create and store one music file in step 334. Step 334 may be performed through the mixer view as illustrated in FIG. 5(C). The mixer view creates, displays, and provides music files reproduced in the plural channels as one music file by setting a switching point to a file to be reproduced next in a currently reproduced music file in a specific channel to the user.

Exemplary embodiments of the present invention provide operations of a music reproducing apparatus and method of a portable terminal that reproduces and switches between different music files through plural channels and plural output units corresponding thereto.

By using a music reproducing apparatus of a portable terminal, a user's personality may be expressed with respect to a corresponding music file. Because different music files are reproduced in the plural channels, and switching between different channels is possible, a user may selectively listen to desired music.

Furthermore, since various GUIs are provided, a user may fulfill the function as a DJ without having professional experience and knowledge of a DJ.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A music reproducing apparatus of a portable terminal, the apparatus comprising:
a Graphical User Interface (GUI) for providing a guide for controlling output of a music file;
a display unit for displaying the GUI;
a Beats Per Minute (BPM) providing unit for converting the music file into an analog form, and for separating a specific frequency component from the converted music file to provide BPM information of the music file; and
a control unit for comparing BPM information of at least two music files with each other according to the BPM information to reproduce the music file by adjusting an output frequency.

2. The apparatus of claim 1, wherein the BPM providing unit comprises :
a decoder for converting the music file into an analog music file;
a filter for separating a specific frequency component from the converted analog music file; and
a BPM analyzing unit for storing BPM information of the music file passed through the filter and for providing the stored BPM information of the music file when the BPM information is requested.

3. The apparatus of claim 1, wherein the control unit controls selection of a music file to be reproduced through plural channels, simultaneous reproduction of the selected music file through output units corresponding to the respective channels, switches a music file which is being reproduced in a certain channel to a music file which is being reproduced in another channel by setting at least one of a reproducing time and a reproducing point of the music file which is being reproduced in the certain channel, and mixing of the switched music files with different channel outputs to produce and store one music file.

4. The apparatus of claim 1, wherein the GUI comprises:
a main view for displaying information of a music file reproduced through at least one channel after loading a plurality of music files through plural channels, and for displaying a switching point setting at least one of a specific reproducing position or time of a corresponding music file at a corresponding progress bar of a currently reproduced music file when a current reproduction is switched;
a wave view for displaying a corresponding waveform and BPM information of the music file to be reproduced through the plural channels, and providing a user interface through which a switching point of a music file to be reproduced after the currently played music file is set; and
a mixer view for generating and displaying a music file reproduced in the plural channels as one music file by setting a switching point to a file to be reproduced next in the currently reproduced music file in a certain channel executed in the wave view.

5. The apparatus of claim 4, wherein the information of the currently reproduced music file comprises a track name, a reproducing time, a reproducing point, and BPM information of a corresponding music file.

6. The apparatus of claim 4, wherein the main view displays and provides a display image of the currently reproduced music file at a preset area in a rotating disk shape.

7. The apparatus of claim 1, wherein the display unit is implemented as a touch screen, and adjusts a rotation with respect to the image of a disk shape to generate a preset effect sound according to a touch input.

8. The apparatus of claim 1, wherein the output unit includes a loud speaker output unit and a headset output unit.

9. The apparatus of claim 1, wherein the control unit synchronizes BPM patterns of different music files such that the different music files are reproduced in the same BPM pattern.

10. The apparatus of claim 1, wherein the BPM information is bit information with respect to data measuring the number and a period of records when a certain frequency component is at least one of equal to and greater than a threshold level.

11. A music reproducing method of a portable terminal, the method comprising:
displaying a Graphical User Interface (GUI) providing a guide for controlling output of a music file on a display unit;
selecting a music file to be reproduced through plural channels, and simultaneously reproducing the selected music file through output units corresponding to the plural channels;
displaying at least one of information of a currently reproduced music file and Beats Per Minute (BPM) information of the music file in a certain channel according to an input, and switching a music file which is being reproduced in a certain channel to another music file which is being reproduced in another channel by setting at least one of a reproducing time and a reproducing point of a corresponding music file; and
mixing the switched music file with different channel outputs with each other to create and store one music file.

12. The method of claim 11, wherein the information of the currently reproduced music file comprises a track name, a reproducing time, a reproducing point, and BPM information of a corresponding music file.

13. The method of claim 11, wherein at least one of the reproducing time and the reproducing point is a reproducing start point and a reproducing stop point of a corresponding music file, respectively.

14. The method of claim 11, further comprising:
synchronizing BPM patterns of different music files such that the different music files are reproduced in the same BPM pattern.

15. The method of claim 11, wherein the GUI comprises:
a main view for displaying information of a music file reproduced through at least one channel after loading a plurality of music files through plural channels, and for displaying a switching point setting of at least one of a specific reproducing position and time of a corresponding music file at a corresponding progress bar of the currently reproduced music file when a current reproduction is switched;
a wave view for displaying a corresponding waveform and BPM information of the music file to be reproduced through the plural channels, and providing a user interface through which a switching point of a music file to be reproduced after the currently played music file is set; and
a mixer view for generating and displaying a music file reproducing in the plural channels as one music file by setting a switching point to a file to be reproduced next in the currently reproduced music file in a certain channel executed in the wave view.

16. The method of claim 15, wherein the main view displays and provides a display image of the currently reproduced music file at a preset area in a rotating disk shape.

17. The method of claim 11, further comprising extracting, displaying, and reproducing corresponding stored BPM information of the music file through plural channels.
